(19) United States
(12) Patent Application Publication
(10) Pub. No.: US 2022/0145673 A1
(43) Pub. Date: May 12, 2022

(54) A Remotely Operable Push Button Lock Mechanism

(71) Applicant: TriMark Europe Limited, Leicester (GB)

(72) Inventor: Euan David Nicolas Clark, Leicester (GB)

(73) Assignee: TriMark Europe Limited, Leicester (GB)

(21) Appl. No.: 17/602,171

(22) PCT Filed: Apr. 8, 2020
(86) PCT No.: PCT/EP2020/060078

§ 371 Date: Oct. 7, 2021

(30) Foreign Application Priority Data
Apr. 8, 2019 (GB) 1904952.7

(51) Int. Cl. E05B 81/36; E05B 81/06; E05B 81/16; E05B 81/30; E05B 81/90; E05B 81/78; E05B 85/10; E05B 13/10

(52) U.S. Cl. CPC E05B 81/36; E05B 81/06; E05B 81/16; E05B 81/30; E05B 83/36; E05B 81/78; E05B 85/10; E05B 13/105; E05B 81/90

(57) ABSTRACT

A push button lock mechanism is remotely and manually operable. The mechanism has a lock cylinder that is rotatable when a key is located therein; an actuator that is connected to the lock cylinder to be rotated thereby and that is biased toward an outwards position; a locking gear formed to be rotated by the actuator between a first position in which the actuator is prevented from passing therethrough and a second position in which the actuator can pass therethrough from the outwards position to an inwards position; a push button for linearly moving the actuator through the locking gear from the outwards position to the inwards position; and a remotely operable motor that acts to rotate the locking gear between the first position and the second position when operated. The motor can be remotely operated by a radio frequency fob or any other passive keyless operating device.

### FIELD OF INVENTION

The present invention relates to locking mechanisms, particularly push button locks and handles comprising such locks, as are commonly found on vehicles such as tractors and other off-road vehicles.

### BACKGROUND

Mechanical push button locking handles are commonly used on many vehicles, particularly off-road and commercial vehicles. In these locks a key is inserted in a locking cylinder and rotated through approximately 90° in a first direction to unlock the handle, then rotated back to its original position, and the key is then removed from the locking cylinder. When the handle is unlocked the push button of the handle can then be pressed in to disengage a latch, unlock the vehicle and allow the handle to be used in order to open the vehicle. In order to lock the handle the key is inserted into the locking cylinder and rotated 90° in a second direction to lock the handle. The key is then removed from the locking cylinder. When the handle is locked it is not possible to depress the push button.

Remote keyless entry systems are also increasingly common in many vehicles. In such entry systems a user may have a radio frequency (RF) fob that interacts with a sensing element and a controller located in a locking mechanism that act to lock and unlock the mechanism. In particular, when the sensing element detects a locking signal from the RF fob, usually provided by pressing a button on the fob, then the controller controls the locking mechanism to unlock by operating suitable actuating means. When the sensing element detects an unlocking signal from the RF fob, usually provided by pressing a button on the fob, then the mechanism is operated to lock by suitable actuating means.

There are many locking mechanisms that combine manual locks with remote keyless entry systems that allow a user to either use a RF fob or a key to lock or unlock the locking mechanism. However, there are no good push button locking handles that allow reliable operation by both remote keyless entry and by manual operation. In light of this there is a need for a new locking mechanism.

U.S. Pat. No. 7,194,881 discloses a push button handle comprising both a conventional locking push button mechanism and remotely operable actuating means that can be operated remotely to operate the lock of the push button mechanism. The actuating means is provided in the handle and can be brought into and out of engagement with the push button locking mechanism. The remotely operable actuating means of this document is bulky and there can be issues with the engagement of the actuating means with the push button mechanism. In light of this there is a need for an improved locking mechanism comprising both a push button mechanism and remotely operable actuating means.

### SUMMARY OF INVENTION

The present invention provides a push button lock mechanism that is both directly mechanically operable and is remotely and electrically operable, the push button lock comprising:

a lock cylinder that is rotatable when a key is located therein;

an actuator that is connected to the lock cylinder to be rotated thereby and that is biased towards an outwards position;

a locking gear formed to be rotated by the actuator between a first position in which the actuator is prevented from passing therethrough and a second position in which the actuator can pass therethrough from the outwards position to an inwards position; and

a push button for linearly moving the actuator through the locking gear from the outwards position to the inwards position;

wherein, the push button lock further comprises a remotely electrically operable motor that acts to rotate the locking gear between the first position and the second position when operated;

characterised in that:

the locking gear has a toothed outer surface to allow rotation by the motor and the motor is in permanent geared connection with the motor via an idler gear.

The present invention is advantageous in that it provides a push button lock mechanism that is both directly operable my means of a key and remotely operable by suitable means. In particular, the push button lock mechanism of the present invention can be operated in substantially conventional manner by means of a key inserted in a lock cylinder and is also remotely operable utilising a remotely operable motor that acts to rotate the locking gear when operated.

The lock mechanism of the present invention operates in the following manner In a locked state the locking gear prevents the linear movement of the actuator from the outwards position towards the inwards position. This can be achieved by, for example, providing an aperture in the centre of the locking gear formed such that it will only allow the actuator to pass through when the locking gear is in the second position and the actuator is in a rest position. This may be achieved by shaping the aperture and the actuator appropriately. For example, the actuator may have ribs or other protrusions formed on an outer surface that only align with correspondingly shaped notches in the aperture of the locking gear when the actuator is in the rest position and the locking gear is in the second position. In an unlocked state the locking gear allows the linear movement of the actuator from the outwards position towards the inwards position.

In order to mechanically unlock the locking mechanism a key is inserted into the lock cylinder and rotated to thereby to rotate the lock cylinder through an angle of rotation in a first direction. This acts to rotate the actuator from a rest position through the angle of rotation in the first direction. During this rotation the actuator engages with the locking gear to rotate the locking gear from the first position to the second position. The key is then rotated back through the angle of rotation in a second direction and this moves the actuator back to the rest position but does not rotate the locking gear back to the first position. The locking gear remains in the second position. The lock is thereby mechanically unlocked.

In order to mechanically lock the locking mechanism a key is inserted into the lock cylinder and rotated to thereby to rotate the lock cylinder through an angle of rotation in a second direction. This acts to rotate the actuator from a rest position through the angle of rotation in the second direction. During this rotation the actuator engages with the locking gear to rotate the locking gear from the second position to the first position. The key is then rotated back through the angle of rotation in the first direction and this moves the actuator back to the rest position but does not rotate the locking gear back to the second position. The locking gear remains in the first position. The lock is thereby mechanically locked.

The rotation of the locking gear by the actuator may be achieved in any manner apparent to the person skilled in the art. For example, the rotation of the locking gear may be achieved by forming one or more suitably shaped recesses in the locking gear and one or more cooperatively shaped protrusions on an outer surface of the actuator that engage with one another when the actuator is rotated. By forming the recess to have an appropriate shape that is rotationally broader than the cooperatively shaped protrusion the rotation of the locking gear by the actuator that is described above can be achieved. In particular, the one or more recesses of the locking gear may each have a breadth that is substantially equal to the angle of rotation whilst the one or more protrusions of the actuator may have a breadth that is much smaller, for example 50% or less of the angle of rotation.

The remote locking and unlocking of the mechanism is achieved in a similar manner However, instead of the locking gear being rotated by means of the actuator, the locking gear is rotated by the remotely operable motor.

Importantly, the locking and unlocking of the lock mechanism of the present invention can be carried out manually and remotely in any order. That is, if the lock mechanism is unlocked either manually or remotely it can then be subsequently locked either remotely or manually. Similarly, if the lock mechanism is locked either manually or remotely it can then be subsequently unlocked either remotely or manually.

The angle of rotation may be any suitable angle, for example, it may be 45°, 60°, 75°, 90°, 105°, 120°, 135° or any angle therebetween.

The actuator of the present invention may be biased towards the outwards position in any suitable manner For example, the lock mechanism may comprise one or more biasing means, such as a spring, for biasing the actuator towards the outwards position.

The remotely operable motor may be remotely operable by any suitable means known to the person skilled in the art. For example, the remotely operable motor may be operated by a radio frequency (RF) fob. Alternatively, the remotely operable motor may be operated by capacitive sensing of when a person holding a valid electron ID on their person is in contact with the mechanism or a vehicle or lock in which the lock mechanism is mounted. This can be achieved by, for example, the capacitive sensing mechanism disclosed in EP3375960.

If a capacitive sensing mechanism is used to remotely operate the motor of the lock mechanism of the present invention then the mechanism can be located in any suitable location, for example as part of a handle in which the lock mechanism is located or in a door in which the lock mechanism is located or adjacent to said door.

The lock mechanism of the present invention may comprise any suitable means for controlling and operating the remotely operable motor including, but not limited to, suitable sensing elements and suitable control elements.

The motor of the present invention is in permanent geared connection with the locking gear by means of an idler gear. As a result, any rotation of the motor will rotate the locking gear and any rotation of the locking gear will result in rotation of the motor. Permanent geared engagement is advantageous as it simplifies the construction of the mechanism and removes the need for potentially unreliable mechanisms for bringing the motor into and out of engagement with the locking gear. An idler gear is advantageous as it allows the motor to be located away from the locking gear utilising a safe and reliable construction. Although rotation of the locking gear will result in rotation of the motor it is anticipated that the resistance of the motor to rotation will be low and will not adversely affect the manual operation of the lock mechanism.

The locking gear has a toothed outer surface to allow a geared connection with the motor. The motor is also provided with a toothed gear that is rotatable by the locking gear via an idler gear that is in direct engagement with both the motor and the toothed outer surface of the locking gear. That is, the motor is in indirect geared engagement with the locking gear.

The mechanism of the present invention may comprise a substantially unitary housing in which the lock cylinder, locking gear, and actuator are housed. Such a housing may be formed in any manner apparent to a person skilled in the art. If these components are located in a housing then the motor may be located inside or outside of the housing. In either situation the motor may be in engagement with the locking gear via a slot formed in a wall the housing. For example, the motor may be provided adjacent an outer side of the wall the locking gear may be provided adjacent an inner side of the wall and the idler gear may be located such that it extends through the slot in the wall of the housing. The wall of the housing may be an external wall of the housing if the motor is located outside of the housing and may be an internal wall of the housing if the motor is located inside the housing.

In order to allow reliable operation of the lock mechanism the push button may be mounted within a housing or a handle such that it cannot rotate relative to the housing or handle or other body in which the push button is mounted. This can be achieved in any manner apparent to the person skilled in the art. For example, the push button may have an inner section that is not rotationally symmetric and may be mounted in a cooperatively formed bore formed in the housing or handle. In embodiments the push button may have a hexagonal, square, or similarly shaped inner end that is located in a cooperatively shaped bore in the housing or handle.

In order to provide sealing of the lock mechanism the lock mechanism may comprise a sealing member located between the push button and a housing or between the push button and any other body in which the push button is mounted. The sealing member may consist of an o-ring positioned within a suitably formed groove located in an outer surface of the push button.

The lock mechanism may operate a lock in any suitable manner In embodiments of the invention the mechanism may further comprise a latch mechanism operated by linear movement of the actuator from the outwards position to the inwards position through the locking gear.

In order to control rotation of the locking gear by the motor and vice versa it may be preferable that an outer toothed surface of the idler gear comprises a cutaway portion over an angular range in which no teeth are provided and, preferably, the idler gear is substantially absent. For example, the idler gear may only be provided with teeth around a portion of an outer toothed surface that is substantially less than 360°, for example 300°, 270°, 240°, 210°, 180°, or less. By providing a cutaway portion the motor will not rotate the locking gear if the motor rotates the idler gear into the cutaway portion, for example during a fault situation. This would prevent damage of the lock mechanism by the motor. Similarly, the locking gear will not rotate the motor if the locking gear rotates the idler gear into the cutaway portion. The cutaway portion will be sized such that a suitable degree of rotation of the locking gear by the motor is achieved during remote operation of the motor to lock and unlock the lock mechanism. It is understood that the skilled person will be able to determine an appropriate size and shape of the cutaway portion without difficulty.

In embodiments of the invention a cutaway portion of the idler gear may simply be a portion of the idler gear where no teeth are provided. Alternatively, the cutaway portion may be a portion where the idler gear is absent over the relevant angular range. In embodiments where the idler gear is absent it may be advantageous that the lock mechanism further comprises stop means positioned to be located within the cutaway portion of the idler gear and thereby prevent over-rotation of the idler gear. For example, a stationary stop means may be provided that is located in the cutaway portion, for example a protruding member that extends from a housing or other component of the lock mechanism into the cutaway portion, and that prevents over-rotation of the idler gear by blocking rotation of the idler gear beyond the points at which the stop means is brought into contact with the idler gear during rotation of the idler gear. Providing such stop means may further guard against over rotation of the locking gear by the motor and vice versa.

In embodiments of the invention the locking gear of the mechanism comprises detent features that act to gently retain the locking gear in the first position or the second position but allow the locking gear to be rotated therebetween when necessary. Suitable detent features will be apparent to the person skilled in the art. For example, detent features may comprise one or more raised portions formed on an outer surface of the locking gear and one or more complimentary recesses formed on a surface of a bore of a handle of the locking mechanism. Alternatively, one or more raised portions may be formed on a surface of a bore of a handle of the locking mechanism and one or more complimentary recesses may be formed on an outer surface of the locking gear.

In embodiments of the invention the actuator comprises axially extending protrusions on its outer surface; and the locking gear comprises an axially extending recess, the axially extending recess having notches provided in a wall that align with the protrusions of the actuator when the locking gear is in the second position to allow the actuator to extend axially through the locking gear, and the notches of the axially extending recess are misaligned with the protrusions of the actuator when the locking gear is in the first position to prevent the actuator extending axially through the locking gear.

There may be two axially extending protrusions and then may be formed on opposing sides of the actuator and be substantially identical to one another. In alternative embodiments of the invention there may be one, three, or more axially extending protrusions formed on the actuator. As will be readily understood, the notches of the axially extending recess of the locking gear will be sized and shaped to conform to the shape of the axially extending protrusions of the actuator. In particular, the notches will be sized and shaped to allow the actuator to extend axially through the locking gear when the locking gear is in a position where the notches of the locking gear align with the axially extending protrusions of the actuator. In embodiments where the actuator has two axially extending protrusions that are formed on opposing sides of the actuator and are substantially identical to one another then the axially extending recess of the locking gear will have a corresponding “butterfly” shape with a central recess and two opposing notches provide in the wall of the recess.

In the embodiments described immediately above, when the locking gear is in the first position the mechanism may be in a locked state; and when the locking gear is in the second position the mechanism may in an unlocked state.

Axially extending recesses of the locking gear may be shaped to allow the protrusions of the actuator to move the locking gear between the first position and the second position when the actuator extends axially through the locking gear characterised in that the first position is between 20° and 160° away from the second position. That is, in embodiments of the invention the first position may be between 20° and 160° away from the second position, for example the first position may be 30°, 45°, 60°, 75°, 90°, 105°, 120°, 135°, 150° or 160° away from the second position.

In embodiments of the invention where the actuator has axially extending protrusions and the locking gear has a cooperatively shaped axially extending recess inserting a key into the lock cylinder may allow the actuator to be manually rotated to align the axially extending protrusions of the actuator with the notches of the axially extending recess of the locking gear and thereby allow the actuator to be axially extended through the locking gear, wherein when the actuator is manually rotated such that it can be axially extended through the locking gear the mechanism is in a mechanically unlatched state; and when the actuator is manually rotated such that it cannot be axially extended through the locking gear the mechanism is in a mechanically latched state. That is, the mechanism can be manually operated to put the mechanism in a mechanically latched state or a mechanically unlatched state. This can be done independently of any remote operation of the mechanism.

In embodiments of the invention where the actuator has axially extending protrusions and the locking gear has a cooperatively shaped axially extending recess remotely operating the motor may act to rotate the locking gear via the idler gear to align or misalign the axially extending protrusions of the actuator with the notches of the axially extending recess of the locking gear to allow the actuator to be axially extended through the locking gear wherein: when the locking gear is rotated via the idler gear such that the axially extending protrusions of the actuator are aligned with the notches of the axially extending recess of the locking gear the mechanism is in an electronically unlatched state; and when the locking gear is rotated via the idler gear such that the axially extending protrusions of the actuator are misaligned with the notches of the axially extending recess of the locking gear the mechanism is in an electronically latched state. That is, the mechanism can be remotely operated to put the mechanism in an electronically latched state or an electronically unlatched state. This can be done independently of any manual operation of the mechanism.

The lock mechanism of the present invention is particularly suitable for forming part of a handle for a vehicle door. The present invention further provides a handle comprising the lock mechanism of the present invention.

The present invention provides a system comprising a radio frequency fob and a lock mechanism according to any preceding claim, wherein the radio frequency fob can act to operate the motor when located in proximity to the mechanism. The radio frequency fob can either be automatically detected by the locking mechanism of the present invention or can be detected when a suitable button on the fob is pressed by the user.

Further advantages and features of the present invention will be apparent from the embodiment shown in the drawings and described below.

### DRAWINGS

FIG. 1 is an exploded isometric diagram of a push button handle according to an embodiment of the present invention;

FIG. 2 is a cross-section through the push button handle of FIG. 1;

FIG. 3 is an exploded side view of the push button handle of FIGS. 1 and 2; and

FIG. 4 is a three-dimensional view showing components of the handle of the Figures in a locked state;

FIG. 5 is a three-dimensional view showing components of the handle of the Figures is an unlocked state;

FIG. 6 shows a handle and its components in a locked state;

FIG. 7 shows the handle and components of FIG. 6 in an unlocked state;

FIG. 8 shows the handle and components of FIGS. 6 and 7 in an activated state; and

FIG. 9 is an exploded view of the handle of FIGS. 6 to 8.

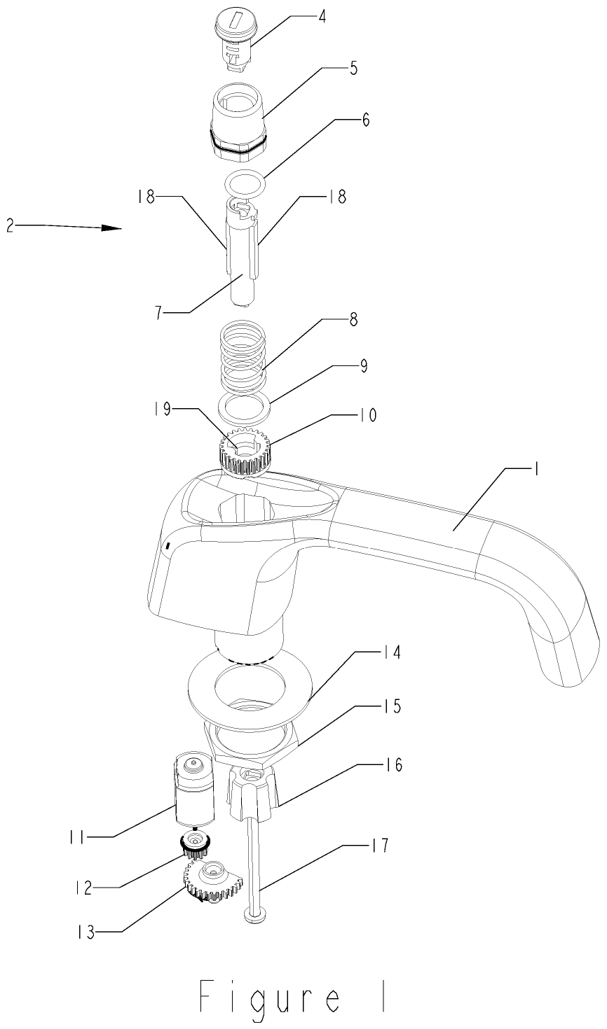

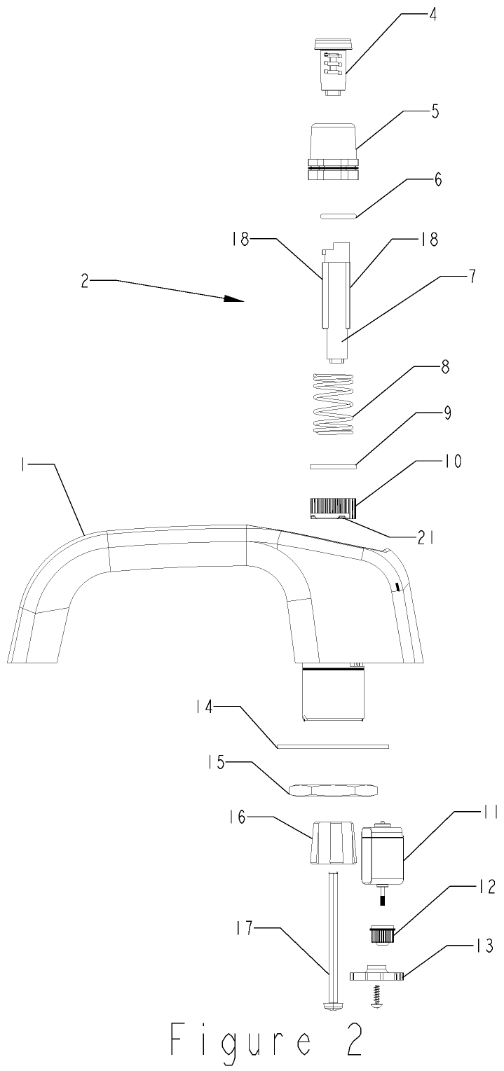

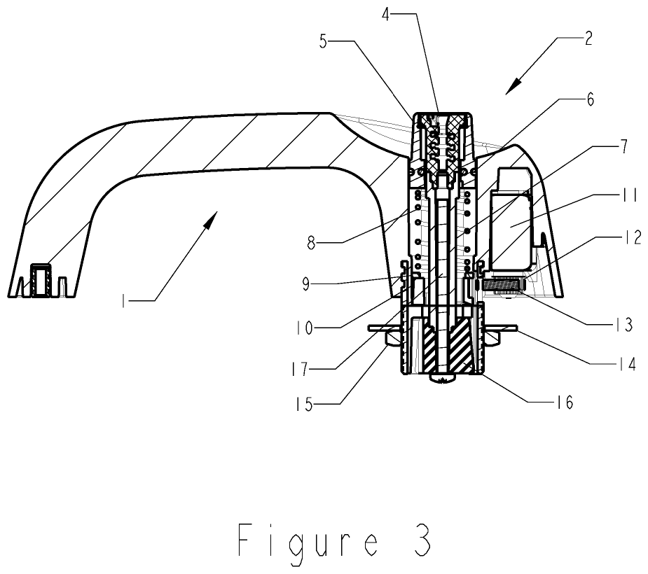

### DETAILED DESCRIPTION

A push button handle 1 including a lock mechanism 2 according to the present invention is shown in the Figures. The lock mechanism 2 is mounted within the handle 1 to operate a door latch (not shown) formed inwardly from the handle.

The lock mechanism 2 comprises: a locking cylinder 4, a push button 5, an o-ring 6, an actuator 7, a biasing spring 8, a first washer 9, a locking gear 10, a remotely operable motor 11, a pinion gear 12, an idler gear 13, a second washer 14, a locking nut 15, a sealing nut 16, and an actuating rod 17.

The locking cylinder 4 is mounted within the push button 5. The push button 5 has a hexagonal inner end that is mounted within a cooperatively formed aperture 20 formed within the handle 1 such that the push button 5 cannot rotate relative to the handle 1. The biasing spring 8 sits on an outer side of the first washer 9 and acts to bias the actuator 7 in an outward direction. The locking nut 15 and second washer 15 hold the locking mechanism 2 in position within the handle 1. The sealing nut 16 is mounted at an inner side of the locking mechanism 2 to locate the locking mechanism within the handle 1.

The locking cylinder 4 is in engagement with the actuator 7 such that rotating the locking cylinder will act to rotate the actuator. The locking cylinder 4 is only rotatable when a key is inserted therein. The actuator 7 has axially extending protrusions 18 formed on its outer surface.

The locking gear 10 have a toothed outer surface and is in geared engagement with the motor 11 by means of the idler gear 13 and the pinion gear 12. This allows the motor 11 to rotate the locking gear 10 when operated. In particular, the motor 11 can be operated to move the locking gear 10 from a first rotational position to a second rotational position and from the second rotational position to the first rotational position. By doing this the locking mechanism 2 can be locked and unlocked.

The idler gear 13 has a cutaway portion such that only approximately 210° of its outer surface is toothed, the remaining 150° being substantially absent. This saves space within the housing lock mechanism 2 and ensures that the motor 11 does not act to over-rotate the locking gear 10.

The locking gear 10 has an inner axially extending recess 19. The axially extending recess 19 is sized and shaped to allow the actuator 7 to be moved axially therethrough when the locking gear 10 is in the second rotational position and to prevent the actuator 7 being axially moved therethrough when the locking gear 10 is in the first rotational position. Specifically, this is achieved by notches provided in the wall of the axially extending recess 19 that align with the protrusions 18 of the actuator 7 when the locking gear 10 is in the second rotational position and that are misaligned with the protrusions 18 of the actuator 7 when the locking gear is in the first rotational position.

The axially extending recess 19 of the locking gear 10 is also shaped to allow the protrusions 18 of the actuator 7 to move the locking gear 10 between the first and second rotational positions when the actuator 7 is rotated by the locking cylinder 4. In particular, inserting a key into the locking cylinder 4 allows the locking cylinder 4 and thereby the actuator 7 to be rotated. When the lock mechanism 2 is locked and the locking gear 10 is in the first position, rotating the locking cylinder 4 and actuator 7 in a first direction through 90° by means of a key inserted in the locking cylinder will cause the protrusions 18 of the actuator 7 to act on the axially extending recess 19 of the locking gear 10 to rotate the locking gear 10 through 90° to the second position. Rotating the locking cylinder 4 back to its original rest position will not then rotate the locking gear 10 back from the second position. This is because in this movement of the actuator back to the original rest position the protrusions 18 of the actuator 7 do not engage with the axially extending recess 19 of the locking gear. The key can then be removed from the locking cylinder 4 and the locking mechanism 2 is unlocked.

When the lock mechanism 2 is unlocked and the locking gear 10 is in the second position, rotating the locking cylinder 4 and actuator 7 in a second direction through 90° by means of a key inserted in the locking cylinder will cause the protrusions 18 of the actuator 7 to act on the axially extending recess 19 of the locking gear 10 to rotate the locking gear 10 through 90° from the second position to the first position. Rotating the locking cylinder 4 back to its original rest position will not rotate the locking gear 10 back from the first position. This is because in this movement the protrusions 18 of the actuator 7 do not engage with the axially extending recess 19 of the locking gear. The key can then be removed from the locking cylinder 4 and the locking mechanism 2 is locked.

When the locking mechanism 2 is unlocked the actuator 7 can pass axially through the locking gear 10 as the locking gear is in the second position. As a result, it is possible to depress the push button 5 and move the actuator 7 axially inward. This, in turn, moves the actuating rod 17 inwards to act on a latch mechanism (not shown) and open a door in which the handle is mounted.

When the locking mechanism 2 is locked the actuator 7 cannot pass through the locking gear 10 as the locking gear 10 is in the first position. As a result, the push button 5 cannot be depressed and the door cannot be opened.

Importantly, when the locking mechanism 2 is locked it can be unlocked either remotely by the motor 11 or manually by the locking cylinder 4. Similarly, when the locking mechanism 2 is unlocked it can be locked either remotely by the motor 11 or manually by the locking cylinder 4.

The locking gear 10 is maintained in the first position and the second position by detent features 21. Male detent features are formed in a bore of the handle in which the locking mechanism 2 is mounted and complementary female detent features 21 are formed in a lower surface of the locking gear 10. When the locking gear 10 is rotated between the first position and the second position by either the motor 10 or the locking cylinder 4 the locking gear 10 is able to move outwardly, against the action of the biasing spring 8, to disengage the male and female detent features 21, thereby allowing the locking gear 10 to rotate. The detent features are formed such that they are only engaged when the locking gear is in either the first or the second position.

The motor 11 is operated, via a controller, by a radio frequency fob (not shown). When an unlock button on the fob is pressed the controller will determine the position of the locking gear 10. If the locking gear 10 is in the second position no action will be taken. If the locking gear 10 is in the first position the controller will control the motor 11 to rotate the locking gear 10 from the first position to the second position. Similarly, when a lock button on the fob is pressed the controller will determine the position of the locking gear 10. If the locking gear 10 is in the first position no action will be taken. If the locking gear 10 is in the second position the controller will control the motor 11 to rotate the locking gear 10 from the second position to the first position.

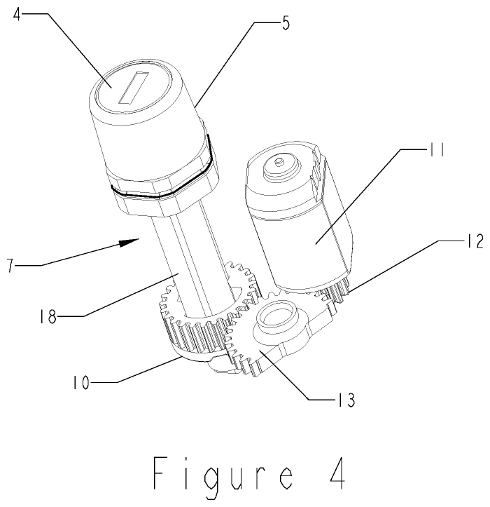

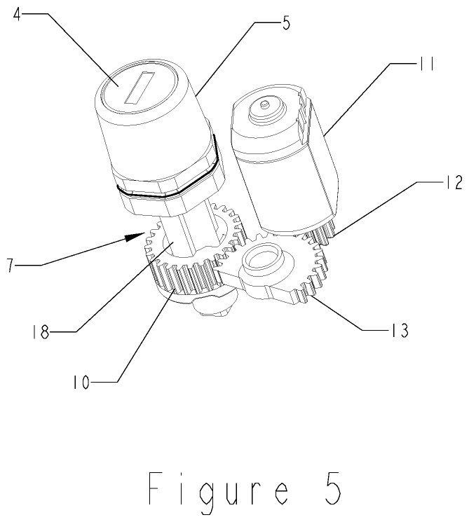

FIGS. 4 and 5 show selected component of the lock mechanism 2 when the mechanism is an locked state (FIG. 4) and when it is in an unlocked state with the push button 5 depressed (FIG. 5). The cutaway portion of the idler gear 13 can be clearly seen in FIGS. 4 and 5. During normal operation of the lock mechanism 2 the idler gear 13 remains meshed with the pinion gear 12 of the motor 11 and with the locking gear 10. Due to the provision of the cutaway portion, in embodiments of the invention, stop means (not shown) can be provided to prevent over rotation of the locking gear 10 and/or motor 11 during manual and remote operation of the locking mechanism 2. FIGS. 4 and 5 also more clearly show the shape of the axially extending recess 19 of the locking gear 10 in relation to the protrusions 18 of the actuator 7. The depression of the push button 5 and the movement of the actuator 7 through the recess 19 of the locking gear 10 is also clearly shown in FIG. 5.

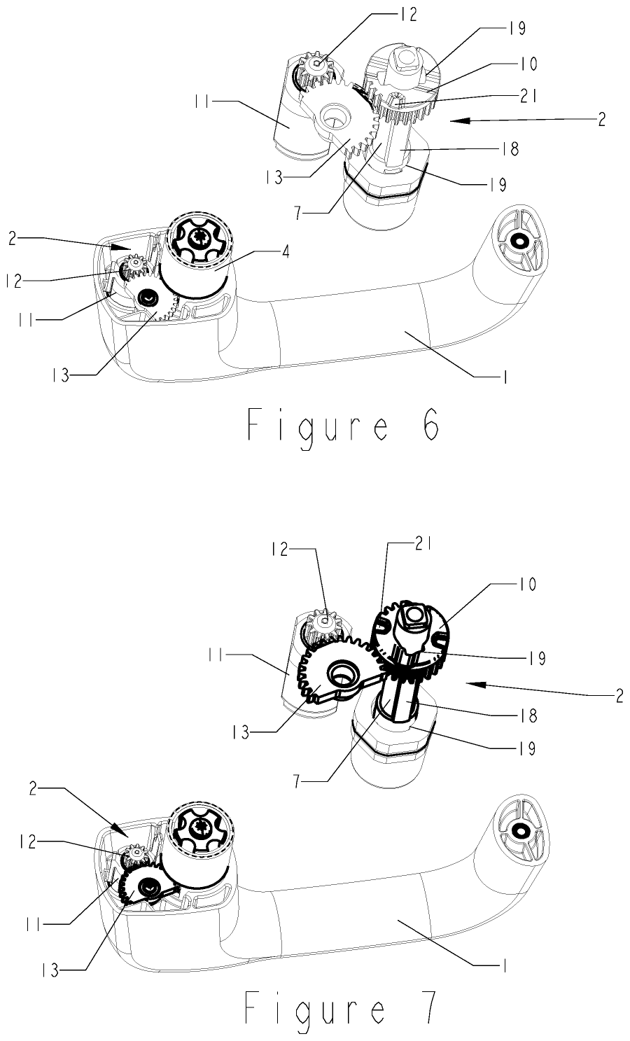

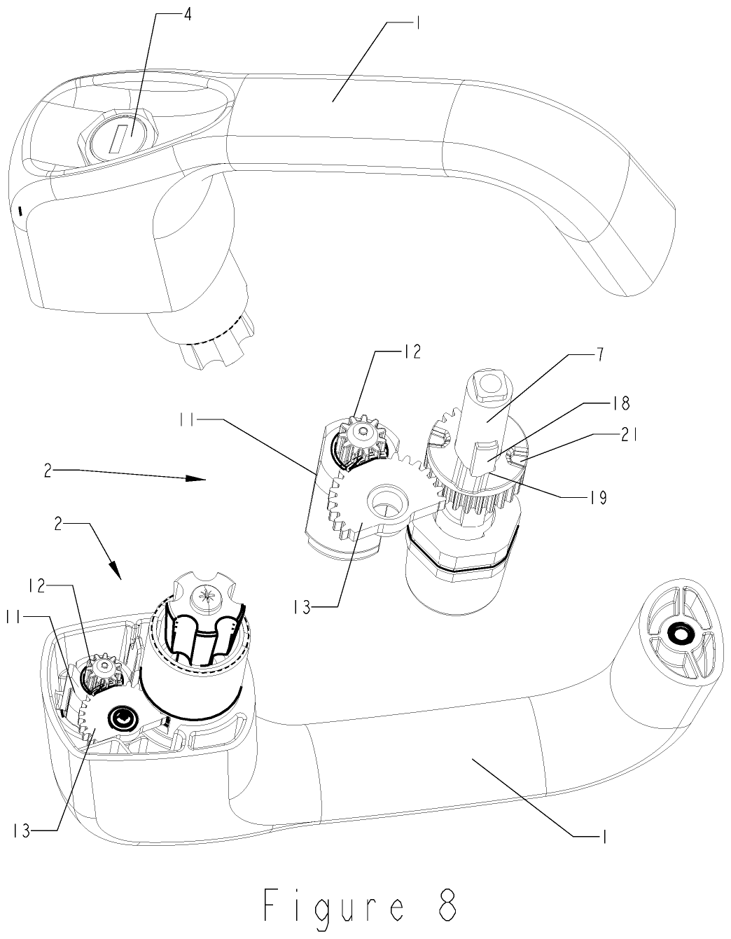

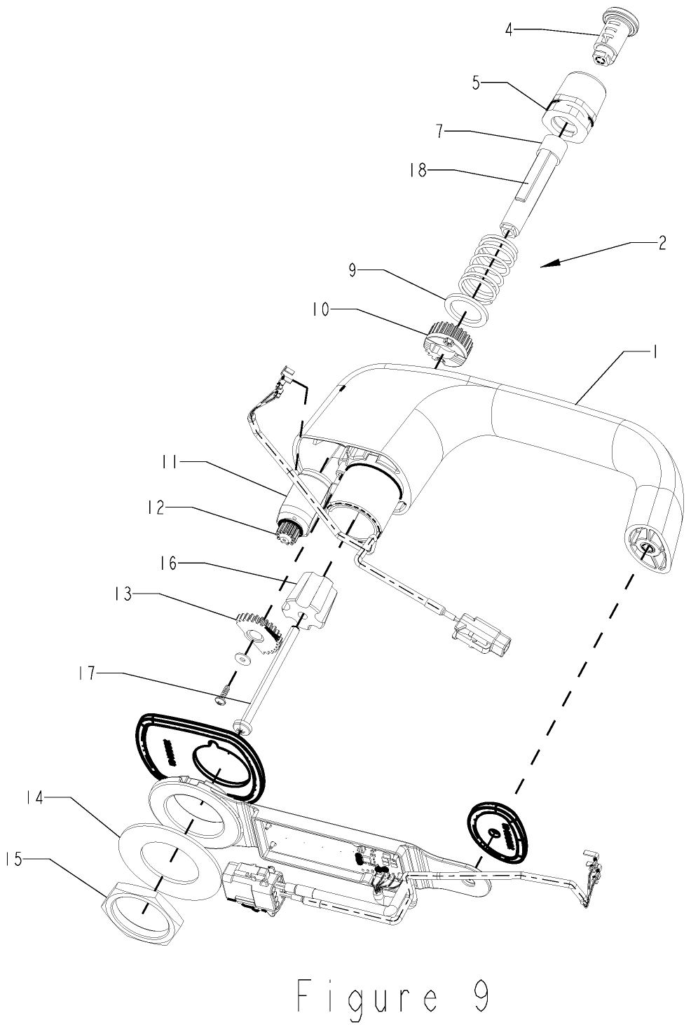

FIGS. 6 to 8 show a handle 1 and a lock mechanism 2 according to an embodiment of the present invention in locked state (FIG. 6), an unlocked state (FIG. 7), and an activated state (FIG. 8). The lock mechanism 2 is formed in substantially the same manner as the previous described embodiments. In particular, the lock mechanism 2 comprises a locking gear 10, an actuator 7, an electrical motor 11, a pinion gear 12, an idler gear 13. The actuator 7 has two axially extending protrusions 18 on opposing sides. The axially extending protrusions 18 are substantially identical to each other. The locking gear 10 comprises an axially extending recess 19 having two notches that are sized and shaped to allow axially extending protrusions 18 of the actuator 7 to pass through the locking gear 10 when it is in a second position and to prevent the actuator 7 to pass through the locking gear 10 when it is in a first position, 90° from the second position.

In FIG. 6 the locking mechanism 2 is in the locked state. In the locked state the notches of the axially extending recess 19 of the locking gear 10 are misaligned with the axially extending protrusions 18 of the actuator 7 and, as a result, the actuator 7 cannot pass through the locking gear 10. This prevents the actuator 7 acting to open a door to which the handle 1 is attached.

In FIG. 7 the locking mechanism 2 is in the unlocked state. In the unlocked state the notches of the axially extending recess 19 of the locking gear 10 are aligned with the axially extending protrusions such that the actuator 7 is able to pass through the locking gear. In this manner, the actuator 7 can act to open a door (not shown) to which the handle 1 is attached.

In FIG. 8 the locking mechanism 2 is in an activated state. In the activated state the actuator 7 is pressed down in an axial direction, through the locking gear 10 to open the door to which the handle 1 is attached.

In order to manually unlock the mechanism 2 of FIGS. 6 to 8 a key (not shown) is inserted into the locking cylinder 4 in a 0° position. The key is used to rotate the locking cylinder 2 through +90° within a housing of the locking cylinder 4, which in turn rotates the actuator 7. The axially extending protrusions 18 of the actuator 7 engages with the locking gear 10, rotating the locking gear 10 through +90°. The locking cylinder 4 is then rotated back to the 0° position. This aligns the axially extending protrusions 18 of the actuator 7 with the notches of the axially extending recess 19 of the locking gear allowing the actuator 7 to pass through the locking gear 10 when the push button 5 is depressed. The axial travel of the actuator 7 is used to disengage a latch, thereby allowing the door to be opened, providing access to an area of a vehicle.

In order to manually lock the mechanism 2 of FIGS. 6 to 8 the key is inserted within the locking cylinder 4 in the 0° position. The key is used to rotate the locking cylinder 4 through −90°, which in turn rotates the actuator 7. The axially extending protrusions 18 of the actuator 6 engage with the locking gear 10, rotating the locking gear 10 through −90°. The locking cylinder is then rotated back to the 0° position. This moves the axially extending protrusions 18 out of alignment with the notches in the axially extending recess 19 of the locking gear 10. This prevents the push button 5 being depressed, preventing any axial movement of the actuator 7 required to release the latch. Thereby leaving the area of the vehicle in a locked state.

The locking gear 10 is retained in either a locked or an unlocked position by detent features 21. Male detent features (not shown) are incorporated in a main bore of the handle 1 and complementary female detent features 21 are formed on a surface of the locking gear 10. When the locking mechanism 2 is moved between locked and un-locked states, the locking gear 4 can move axially upward, against a biasing spring 8 force, disengaging the detent features 21 and allowing the locking gear 10 to rotate. The detent feature locations 21 are indexed such that they engage only when the locking gear 10 is in the locked or unlocked positions. A first (thrust) washer 9 allows the locking gear 10 to rotate under the force imparted by the biasing spring 8 without the spring galling or otherwise damaging the locking gear 10.

The push button 5 incorporates a hexagonal lower section, which runs in the hexagonal section of the bore in the handle 1, to prevent unwanted rotation of the push button 5 with respect to the handle body. The push button 3 also incorporates an O-Ring groove, which in conjunction with an O-Ring forms a seal against the hexagonal section of the bore to prevent dust and water ingress to IP66 level.

The handle 1 and locking mechanism 2 of FIGS. 6 to 8 can be remotely operated in the following manner The handle 1 and locking mechanism 2 can be used in conjunction with a passive keyless entry (PKE) control system and/or activated by pressing buttons on a radio frequency (RF) key fob and/or activated by a person placing their hand inside a “grip area” of a handle 1 while they have a key fob with a valid electronic ID (not shown) on their person.

The locking mechanism 2 is electronically unlocked in the following manner When an authorised un-lock signal is received, a controller supplies power to the motor 11, the resulting rotatory motion of the motor 11 is transmitted through the pinion gear 12 and the idler gear 13 to the locking gear 10, rotating the locking gear 10 through +90°. The idler gear 13 engages with the locking gear 10 through a radial slot in the housing. This rotation aligns the shaped notches of the axially extending recess 19 of the locking gear 10 with the axially extending protrusions 18 of the actuator 7, allowing the actuator 7 to pass through the locking gear 10 when the push button 3 is depressed. Axial travel of the actuator 8 can be used to disengage a latch, thereby allowing a door to be opened, providing access into an area of a vehicle.

The locking mechanism 2 is electronically locked in the following manner When an authorised lock signal is received a controller supplies power to the motor 10 (of reversed polarity with respect to the un-locking function), the resulting rotatory motion of the motor 10 is transmitted through the pinion gear 12 and the idler gear 13 to the locking gear 10; rotating the locking gear 10 through −90°. The idler gear 13 engages with the locking gear 10 through a radial slot in the housing. This moves the notches in the axially extending recess 19 of the locking gear 10 out of alignment with the axially extending protrusions 18 of the actuator 7 preventing the push button 3 being depressed; thus inhibiting the linear travel of the actuator 7 required to release a latch, leaving the area of the vehicle in a locked/secure state.

A key feature of the present invention is that a lock or un-lock function can be performed manually, using the key, or electrically using, for example, buttons on the RF Key fob, or via PKE in any order. That is to say that if the mechanism 2 is unlocked manually using the key, it can be locked using one of the electrical methods, and vice versa.

Unless otherwise indicated by context, any feature of the embodiment of the invention shown in the drawings and described above is independent of any other feature and can be included in an embodiment of a locking mechanism according to the present invention.

1. A push button lock mechanism that is both directly mechanically operable and is remotely and electrically operable, the push button lock comprising:
a lock cylinder that is rotatable when a key is located therein;
an actuator that is connected to the lock cylinder to be rotated thereby and that is biased towards an outwards position;
a locking gear formed to be rotated by the actuator between a first position in which the actuator is prevented from passing therethrough and a second position in which the actuator can pass therethrough from the outwards position to an inwards position; and
a push button for linearly moving the actuator through the locking gear from the outwards position to the inwards position;
wherein, the push button lock further comprises a remotely electrically operable motor that acts to rotate the locking gear between the first position and the second position when operated, and
the locking gear has a toothed outer surface to allow rotation by the motor and the locking gear is in permanent geared connection with the motor via an idler gear.

2. The push button lock mechanism according to claim 1 further comprising a housing in which the lock cylinder, locking gear, and actuator are housed.

3. The push button lock mechanism according to claim 1 further comprising a housing in which the motor and the idler gear are housed.

4. The push button lock mechanism according to claim 2, wherein the lock cylinder, locking gear, actuator, motor, and idler gear are housed in the same housing.

5. The push button lock mechanism according to claim 2, in which the motor is engagement with the locking gear via a slot in the housing.

6. The push button lock mechanism according to claim 2, wherein the push button is mounted in the housing or in a handle such that it cannot rotate relative to the housing or the handle.

7. The push button lock mechanism according to claim 2, further comprising a sealing member located between the push button and the housing or between the push button and the handle.

8. A lock comprising the push button lock mechanism of claim 1, further comprising a latch mechanism operated by linear movement of the actuator through the locking gear.

9. The push button lock mechanism according to claim 1, wherein an outer toothed surface of the idler gear comprises a cutaway portion.

10. The push button lock mechanism according to claim 9, further comprising stop means positioned to be located within the cutaway portion of the idler gear and thereby prevent over-rotation of the idler gear.

11. The push button lock mechanism according to claim 1, wherein the locking gear comprises detent features.

12. The push button lock mechanism according to claim 11, wherein the detent features are formed in a bore of a handle of the locking mechanism and complementary detent features are formed in a lower surface of the locking gear.

13. The push button lock mechanism according to claim 1, wherein:
the actuator comprises axially extending protrusions on its outer surface; and
the locking gear comprises an axially extending recess, the axially extending recess having notches provided in a wall that align with the protrusions of the actuator when the locking gear is in the second position to allow the actuator to extend axially through the locking gear, and the notches of the axially extending recess are misaligned with the protrusions of the actuator when the locking gear is in the first position to prevent the actuator extending axially through the locking gear.

14. The push button lock mechanism according to claim 13 wherein when the locking gear is in the first position the mechanism is in a locked state; and when the locking gear is in the second position the mechanism is in an unlocked state.

15. The push button lock mechanism according to claim 13, wherein the axially extending recess is shaped to allow the protrusions of the actuator to move the locking gear between the first position and the second position when the actuator extends axially through the locking gear characterised in that wherein the first position is between 20° and 160° away from the second position.

16. The push button lock mechanism according to claim 14, wherein the first position is about 90° from the second position.

17. The push button lock mechanism according to claim 13, wherein
inserting a key into the lock cylinder allows the actuator to be manually rotated to align the axially extending protrusions of the actuator with the notches of the axially extending recess of the locking gear and thereby allow the actuator to be axially extended through the locking gear,
when the actuator is manually rotated such that it can be axially extended through the locking gear, the mechanism is in a mechanically unlatched state, and
when the actuator is manually rotated such that it cannot be axially extended through the locking gear the mechanism is in a mechanically latched state.

18. The push button lock mechanism according to claim 13, wherein
remotely operating the motor can act to rotate the locking gear via the idler gear to align or misalign the axially extending protrusions of the actuator with the notches of the axially extending recess of the locking gear to allow the actuator to be axially extended through the locking gear,
when the locking gear is rotated via the idler gear such that the axially extending protrusions of the actuator are aligned with the notches of the axially extending recess of the locking gear, the mechanism is in an electronically unlatched state, and
when the locking gear is rotated via the idler gear such that the axially extending protrusions of the actuator are misaligned with the notches of the axially extending recess of the locking gear the mechanism is in an electronically latched state.

19. A handle comprising the push button lock mechanism of claim 1.

20. A system comprising a remote switch or radio frequency fob and the push button lock mechanism according to claim 1, wherein the remote switch or radio frequency fob can act to operate the electric motor when located in proximity to the mechanism.
